(19) United States
(12) Patent Application Publication
(10) Pub. No.: US 2026/0206022 A1
(43) Pub. Date: Jul. 16, 2026

(54) TRIGGER FRAME USER INFORMATION FIELD DESIGN

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Gaurang NAIK, San Diego, CA (US); Sanket Sanjay KALAMKAR, San Diego, CA (US); Sherief HELWA, San Diego, CA (US); Giovanni CHISCI, San Diego, CA (US); Sai Yiu Duncan HO, San Diego, CA (US)

(21) Appl. No.: 19/445,303

(22) Filed: Jan. 9, 2026

Related U.S. Application Data
(60) Provisional application No. 63/744,251, filed on Jan. 11, 2025.

(51) Int. Cl. H04W 72/12; H04L 1/00

(52) U.S. Cl. CPC H04W 72/12; H04L 1/0006

(57) ABSTRACT

Certain aspects of the present disclosure provide techniques for trigger frame user information field design. An example method generally includes generating a frame that includes a block of user information fields, wherein information is carried as partial information in at least two of the user information fields, and outputting the frame for transmission to one or more wireless nodes

### CROSS-REFERENCE TO RELATED APPLICATION(S)

This application claims priority to and benefit of U.S. Provisional Patent Application No. 63/744,251 , filed Jan. 11, 2025, which is hereby incorporated by reference herein.

### TECHNICAL FIELD

This disclosure relates generally to wireless communication, and more specifically, to trigger frame design.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication. The method includes generating a frame that includes a block of user information fields, wherein information is carried as partial information in at least two of the user information fields and outputting the frame for transmission to one or more wireless nodes.

Another innovative aspect of the subject matter described in this disclosure can be implemented in a method for wireless communication. The method includes obtaining a frame that includes a block of user information fields, wherein information is carried as partial information in at least two of the user information fields and processing the frame to obtain the information.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows an example call flow diagram, in accordance with aspects of the present disclosure.

FIG. 5 shows an example trigger frame including one or more frame check sequence (FCS) fields, in accordance with aspects of the present disclosure.

FIG. 6 shows an example FCS field, in accordance with aspects of the present disclosure.

FIG. 7 shows an example trigger frame including packet number/message integrity check (PN/MIC), in accordance with aspects of the present disclosure.

FIG. 8 shows an example trigger frame, in accordance with aspects of the present disclosure.

FIG. 9 shows an example trigger frame including PN/MIC and FCS fields, in accordance with aspects of the present disclosure.

FIG. 10 shows an example flowchart illustrating example processes performable by or at a wireless node, in accordance with aspects of the present disclosure.

FIG. 11 shows an example flowchart illustrating example processes performable by or at a wireless node, in accordance with aspects of the present disclosure.

FIG. 12 shows a block diagram of an example wireless communication device

Like reference numbers and designations in the various drawings indicate like elements.

### DETAILED DESCRIPTION

Certain mechanisms may be applicable to communications between wireless nodes, such as between access point (AP) and non-AP stations (STAs), between APs, and/or between non-AP STAs.

In the context of 802.11 networking, “FCS” stands for “Frame Check Sequence,” which is a field within a wireless frame used to detect errors during transmission by verifying the integrity of the data received through a checksum calculation. Essentially, FCS acts as a mechanism to ensure the data received is not corrupted during transmission.

An “intermediate FCS” (I-FCS) generally refers to a Frame Check Sequence (FCS) field added within a control frame that is used by intermediate devices, like a relay node, to verify the integrity of the data received before forwarding it further, essentially acting as a check point during data relaying. I-FCS allows for error detection at each hop in a multi-hop transmission.

A “MIC” stands for “Message Integrity Check,” which is a security feature that verifies the authenticity of a data packet by adding a unique code generated by the sender (e.g., using a packet number (PN)), ensuring that the data hasn't been tampered with during transmission. MIC is a way to detect if a packet has been altered by a malicious entity while traveling through the network.

In Wi-Fi 6 (e.g., 802.11ax), a trigger frame is a control frame sent by the AP to schedule and coordinate uplink transmissions from multiple devices. This mechanism is designed to enable efficient multi-user communication by allowing multiple devices to transmit simultaneously, leveraging technologies like Multi-User Orthogonal Frequency Division Multiple Access (MU-OFDMA) and Multi-User Multiple Input Multiple Output (MU-MIMO). The trigger frame provides critical information to client devices, such as Resource Unit (RU) allocations, which specify the frequency subcarriers each device should use for its uplink transmission. It also includes details on transmit power, modulation and coding schemes, and timing, ensuring all devices transmit their data in a synchronized and non-overlapping manner. By managing these parameters, the AP reduces contention and improves overall network efficiency, particularly in environments with many connected devices.

Trigger frames are particularly beneficial in high-density scenarios, such as offices, classrooms, or stadiums, where many devices need to share the same wireless medium. They are also valuable for Internet of Things (IoT) applications, where numerous devices send small data packets intermittently. By coordinating uplink transmissions, trigger frames help minimize delays, enhance spectral efficiency, and ensure reliable communication, even in challenging network conditions.

PN and MIC fields may be present in certain Trigger frames (e.g., when the Trigger frame is protected). Intermediate FCS (I-FCS) may be present in certain Trigger frames (e.g., when the Trigger frame is an initial control frame (ICF)).

If the intermediate FCS and the PN/MIC fields are both present in a Trigger frame, then the intermediate FCS may appear immediately after the PN/MIC fields. Additionally, the I-FCS, PN and MIC fields may be carried in “dedicated” User Info fields.

Aspects of the present disclosure relate to the locations of the intermediate FCS, PN and MIC fields in the Trigger frame. In some aspects, for example, I-FCS is 32 bits, PN is 6 octets & MIC is 16 octets. Aspects of the present disclosure define additional signaling in the Trigger frame related to the locations of these fields.

### Example Wireless Communication Network

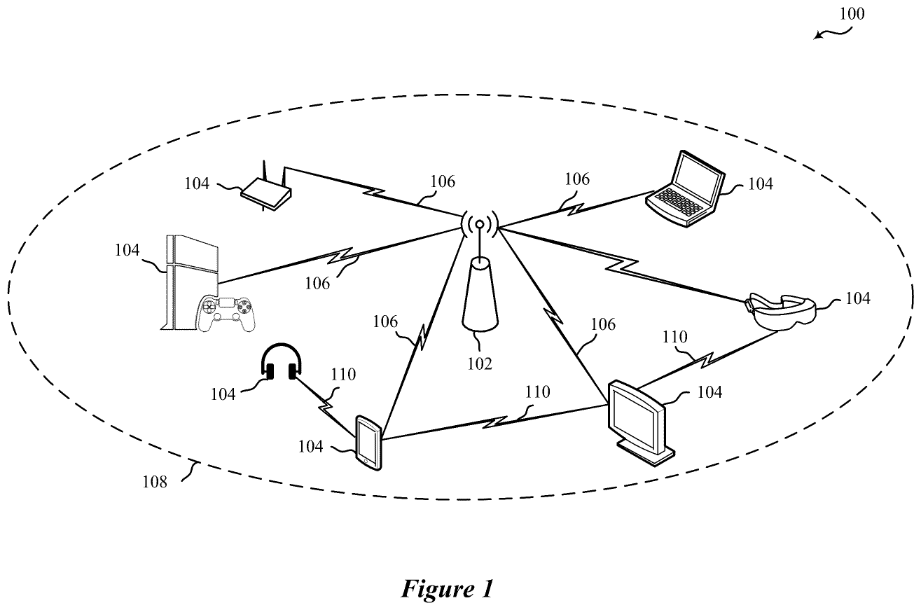

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

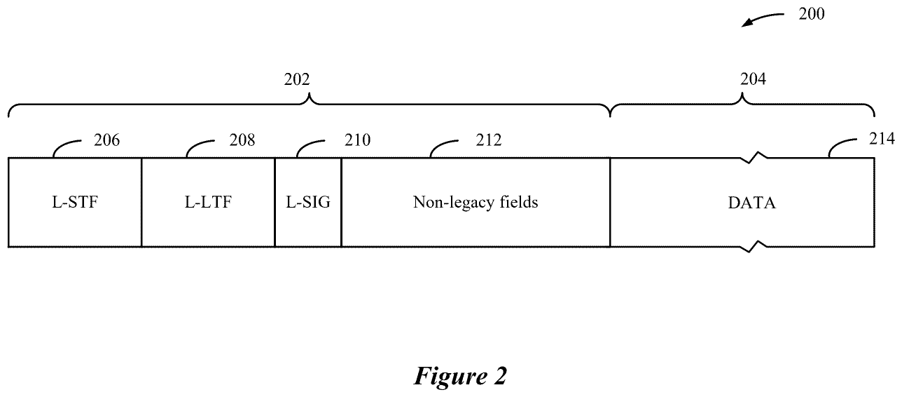

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

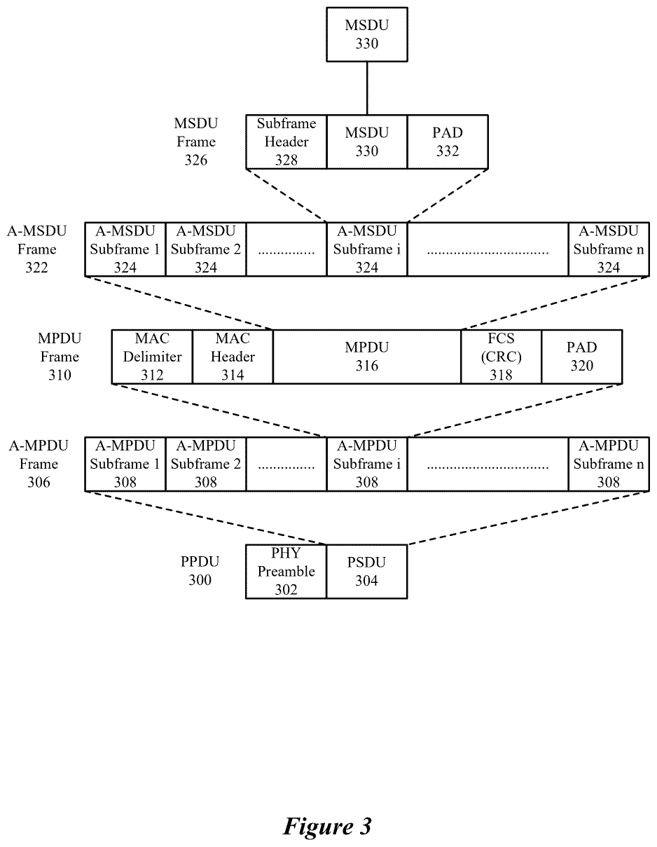

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs). For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Aspects Related Trigger Frame User Information Field Design

As noted above, aspects of the present disclosure relate to the locations of the intermediate FCS, PN and MIC fields in the Trigger frame. Aspects of the present disclosure define additional signaling in the Trigger frame related to the locations of these fields.

The locations and frame design may be determined, in some cases, based on the size and format of various fields. For example, an I-FCS may be 32 bits, a PN may be 6 octets, and a MIC may be 16 octets.

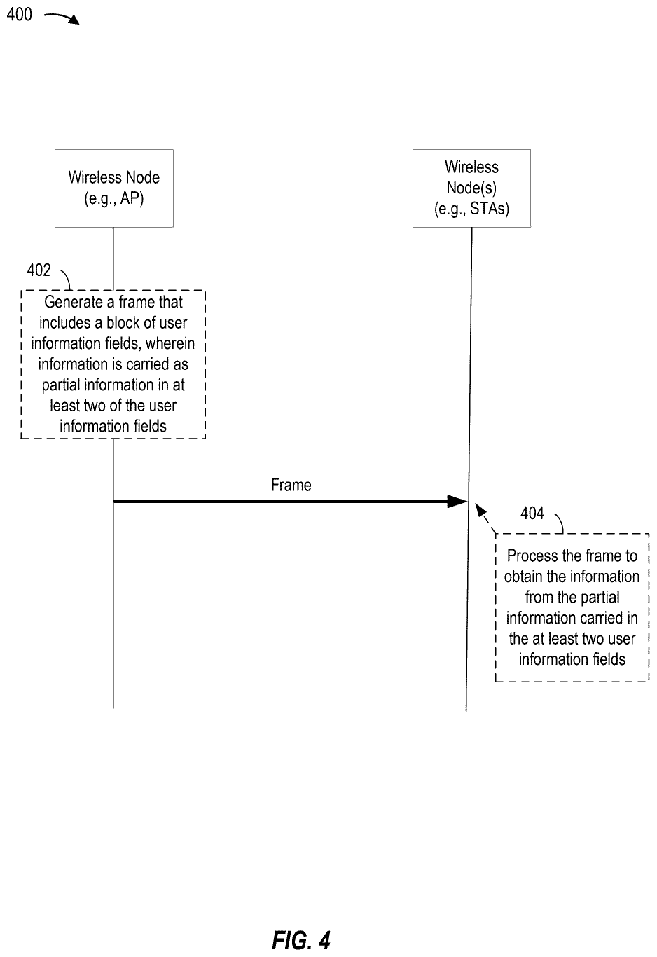

These techniques may be understood with reference to FIG. 4, which shows an example call flow diagram 400, in accordance with aspects of the present disclosure.

As illustrated at 402, a wireless node (e.g., an AP) may generate (e.g., and output/transmit) a frame (e.g., a trigger frame) that includes a block of user information fields, where information is carried as partial information in at least two of the user information fields.

As illustrated at 404, one or more wireless nodes (e.g., STAs) may process the frame to obtain the information from the partial information carried in the at least two user information fields.

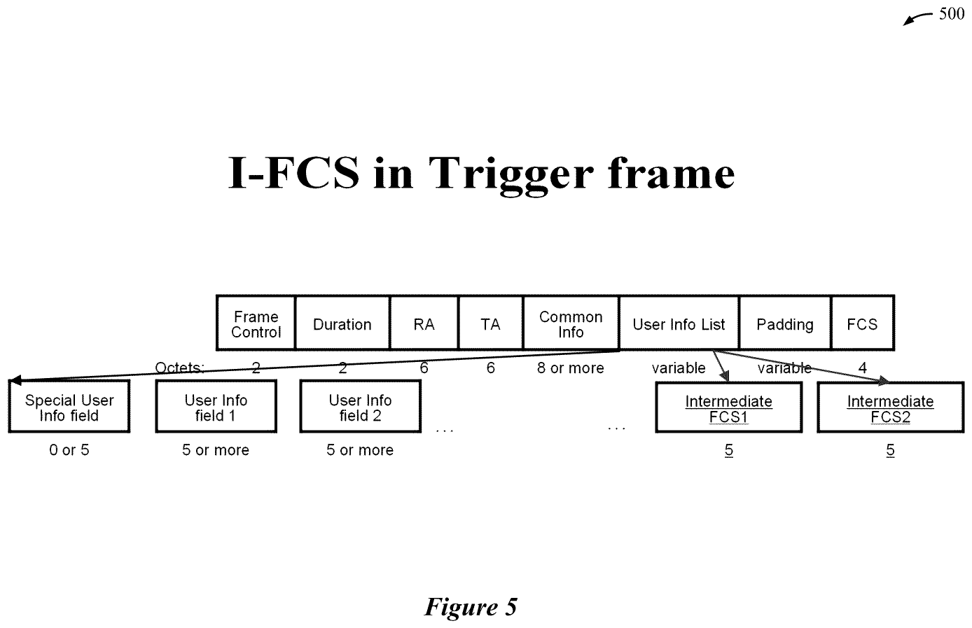

FIG. 5 shows an example trigger frame 500 including one or more frame check sequence (FCS) fields, in accordance with aspects of the present disclosure.

In some aspects, two “I-FCS” User Info fields may be defined that carry the intermediate FCS bits. In some cases, the FCS may be a 32-bit I-FCS, which may be a 32-bit cyclic redundancy check (CRC) value.

In a typical 5 octet user information (User Info) field, there may only 28 bits are available, since 12 bits are used for an association ID (AID12). Hence, as illustrated, two (or more) User Info fields may be used to carry 32-bit CRC. In the illustrated example, two User Info fields carry partial information (e.g., a subset of the 32 bits) for the I-FCS (labeled I-FCS1 and I-FCS2).

In some cases, the first User Info field (I-FCS1) may contains 28 bits of CRC-32 and the 2nd User Info (with I-FCS2) may contain the other 4 bits of CRC-32. This leaves 24 bits reserved in the 2nd I-FCS field (which cannot be protected by the I-FCS).

In some cases, to differentiate these “I-FCS” User Info fields from others, a distinct AID12 may be utilized (e.g., expect to use a value that is currently reserved such as value 2010).

In some aspects, I-FCS may be calculated over all the fields of the MPDU up to and excluding the I-FCS. The 2nd I-FCS2 field may appear immediately after the 1st I-FCS field.

In some cases, an ordering rule may be enforced. For example, such an ordering rule may dictate that I-FCS fields appear after the last User Info field that is addressed to a UHR STA that requires I-FCS. Other User Info fields (e.g., addressed to other UHR STAs or UHR STAs that do not require I-FCS) may appear after “I-FCS.” In some cases, the I-FCS calculation may not need to protect the AID12 of “I-FCS” User Info fields.

In some aspects, these partial I-FCSs may be byte aligned within the User Info fields. This would shift the start index of the partial I-FCS by 4 bits after AID12.

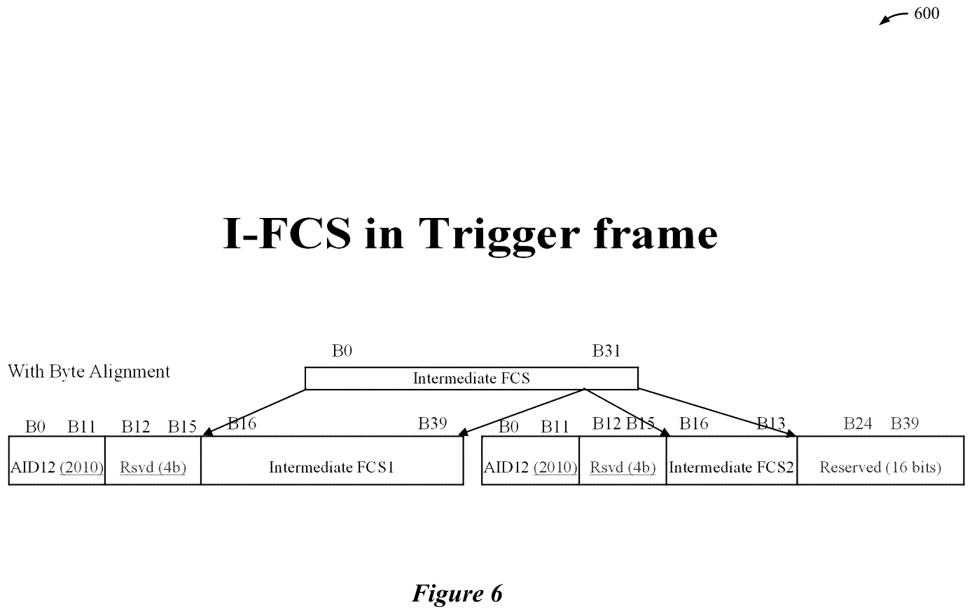

FIG. 6 shows an example FCS field 600, in accordance with aspects of the present disclosure. In the illustrated example, a 32 bit I-FCS field may be split into 24 bit and 8 bit parts in separate User Info (UI) fields. The illustrated 24 bit/8 bit split option may leave an extra 16 reserved bits in last user info.

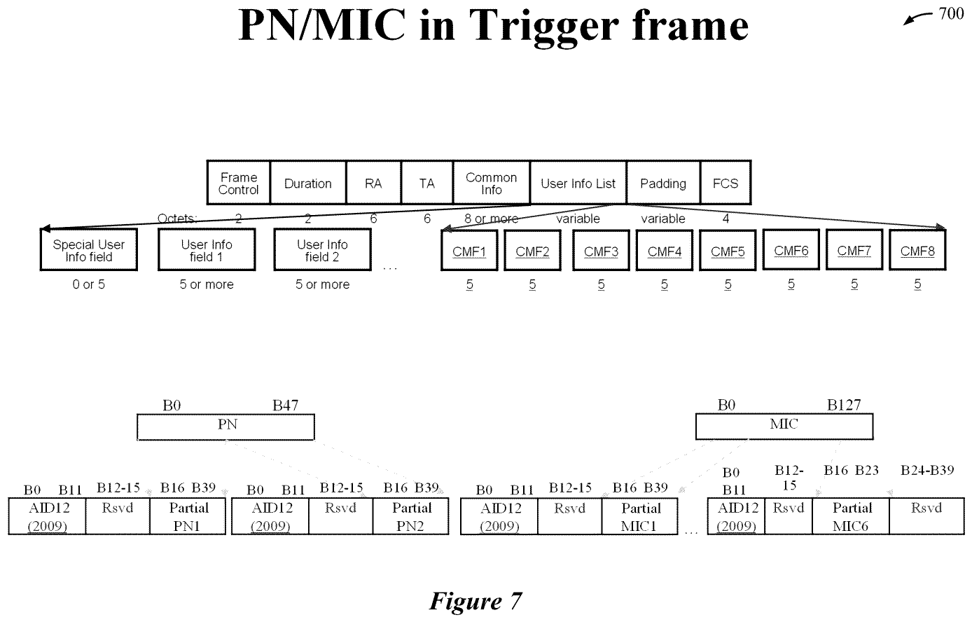

FIG. 7 shows an example trigger frame 700 including packet number/message integrity check (PN/MIC), in accordance with aspects of the present disclosure.

In some aspects, eight control and/or management feedback (CMF) User Info fields may be defined, to carry the PN/MIC. User Info is 5 octets, 12 bits used by AID12 and 4 bits need to be reserved for byte alignment. Thus, two User Info fields may be used to carry the PN (which is 6 octets). 1st User Info field contains 24 bits of PN and 2nd User Info contains the other 24 bits of PN.

6 User Info fields may be used for the rest of the MIC (which is 16 octets or 128 bits). This may leave an extra 16 bits reserved in the last User Info field.

To differentiate these “PN/MIC” User Info fields from others, a distinct AID12 may be used (e.g., using a value that is currently reserved such as value 2009). These User Info fields may appear in order, and immediately after each other.

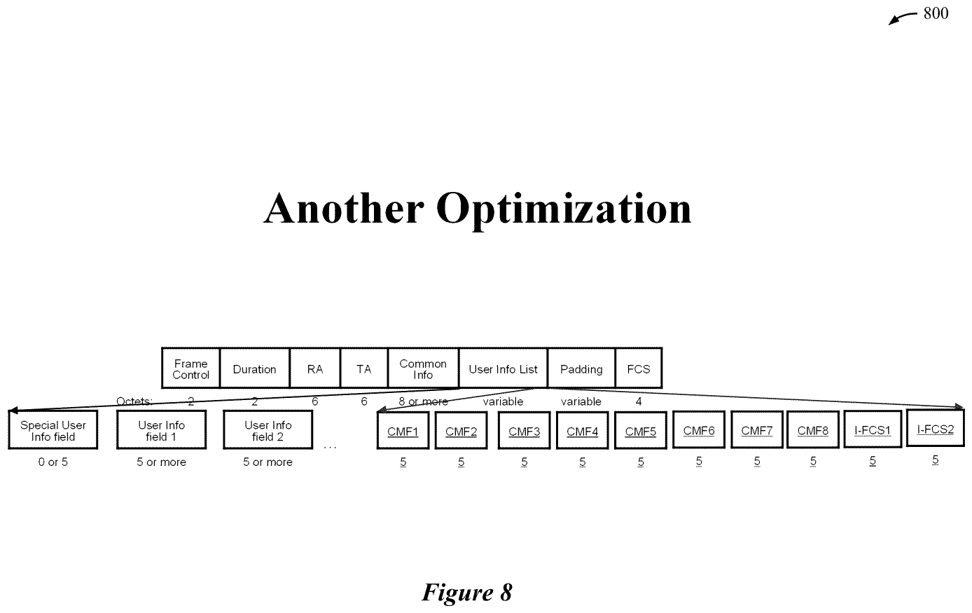

FIG. 8 shows an example trigger frame 800, in accordance with aspects of the present disclosure.

In some aspects, the location of the (e.g., UI fields conveying) I-FCS may be indicated. Such an I-FCS Location field may be located as early as possible in the frame. A viable, earliest candidate is Special User info field. 8 bits may be allocated for this to cover a maximum number of 256 User Info fields.

The I-FCS Location field may indicate the number of User Info fields that appear after the Special User Info field and before the first “I-FCS” User Info field. In some cases, the I-FCS Location field may also count the “CMF” User Info fields, if present.

In some cases, one or more bits may be included in a trigger frame to indicate the presence of PN/MIC and/or I-FCS (e.g., an I-FCS present bit and a protected control field to indicate PN/MIC).

The I-FCS Location field may be reserved if the I-FCS Present bit in the Common Info field is 0 (e.g., meaning I-FCS not present). If I-FCS Present (P) bit is 1 and Protected Control (PC) is 0 then I-FCS location may point to I-FCS 1. If I-FCS P is 0 and PC is 1 then I-FCS/CMF location points to CMF 1. In some cases, the location field may be referred to as an I-FCS/CMF location field. If I-FCS P is 1 and PC is 1, then this field may point to CMF1 or I-FCS1. In the case of I-FCS1, the location of the CMF1 may be obtained by subtracting 7 user info fields from that I-FCS/CMF location field.

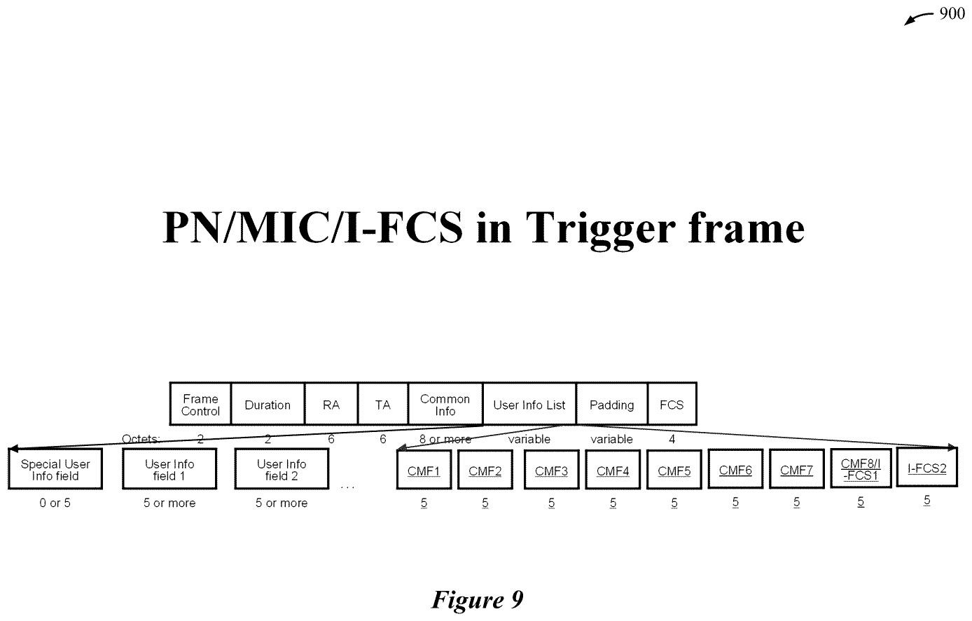

FIG. 9 shows an example trigger frame 900 including PN/MIC and FCS fields, in accordance with aspects of the present disclosure.

In some aspects, if both PN/MIC and I-FCS are present, then I-FCS may appear immediately after PN/MIC. In such cases, the I-FCS Present bit (in Common Info) is 1 if the I-FCS is present; otherwise not present. In such cases, the Protected Control bit (e.g., in a Common Info field) is 1 if PN/MIC is present; otherwise not present.

For certain designs described proposed herein, 8 dedicated User Info fields for PN/MIC and 2 dedicated User Info fields for I-FCS (total 10 User Info fields) may be used. The last 16 bits of the last dedicated User Info field that carry CMF (PN/MIC) are reserved. The last 16 bits of the other last dedicated User Info field that carry I-FCS are reserved.

As illustrated in FIG. 9, these reserved bits may be leveraged to reduce to 9 User Info fields. The first 16 bits of the I-FCS may be carried in the last (8^{th}) User Info field of CMF, and the other 16 bits can be carried in the following User Info field (9^{th).}

Additionally, a design using the same dedicated User Info for PN/MIC/I-FCS (e.g., common value 2009) may be used. If I-FCS Present bit is 1 and Protected Control bit is 0 then only I-FCS (2 User Info fields) may be present. I-FCS populates each dedicated User Info field in order.

If I-FCS Present is 0 and Protected Control is 1 then only PN/MIC may be present (8 User Info fields). PN/MIC populate each dedicated User Info field in order.

If I-FCS Present is 1 and Protected Control is 1 then PN/MIC/I-FCS may be present (9 User Info fields). PN/MIC/I-FCS populate each dedicated User Info field in order.

In some cases, mechanisms may be used to increase the bits that can be used in a User Info field from 28 bits to 32 bits. In some aspects, for example, instead of using one dedicated value of the AID12 for carrying I-FCS/PN/MID, certain techniques disclosed herein may dedicate a range of dedicated values of the AID12 so that 4 bits of that range can be used to carry information. A drawback of this approach is that it uses a wider space of available AID space for non-AID purposes and increased complexity.

Another option is to simply carry a truncated version of the CRC or reduce the PN/MIC sizes (but this option may not be preferred since 32 bits may be standardized).

This way it saves in number of User Info fields. I-FCS fits in 1 User Info instead of 2 (saves 5 octets). PN/MIC fits in 6 User Info instead of 8 (saves 10 octets). PN/MIC/I-FCS fits in 7 User Info fields instead of 10 (or 9 depending on the design).

The principles described above can be generalized to containers of other information, in accordance with the present disclosure. For example, the CMF field can be another type of field (e.g., but may still be referred to as CMF herein) as in control and/or management feedback field and can be carried in one or more dedicated User Info fields. These fields can carry control information or management information (e.g., feedback, reports, requests, etc.) and can be addressed to each STA (e.g., an identifier (AID12 or another following ID) identifies which STA, or to all STAs (AID12 uses a special value e.g., 2011). The Common Info field may have a similar bit (e.g., CMF Present bit) that can serve the same purpose as the other mechanisms described above.

### Example Methods

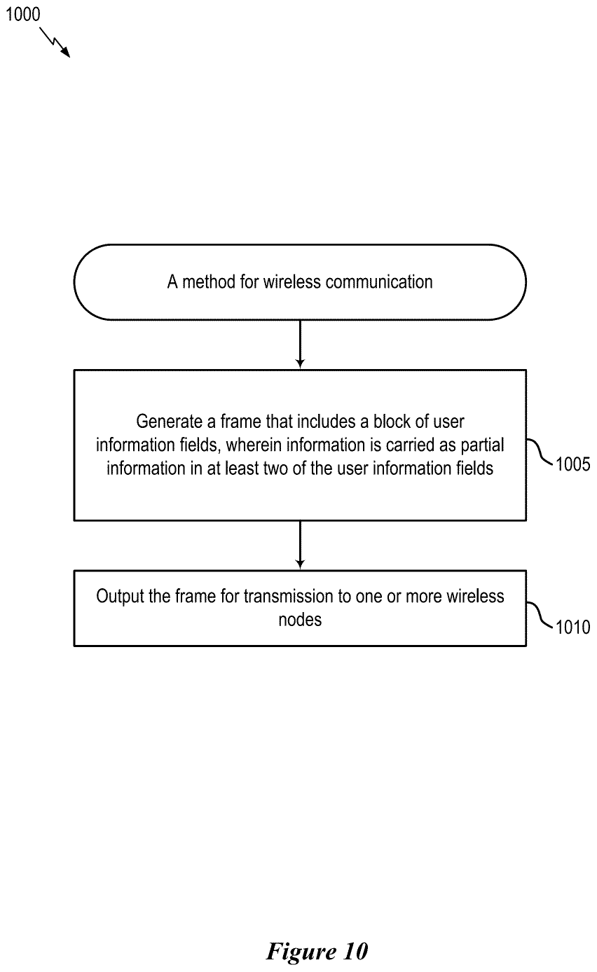

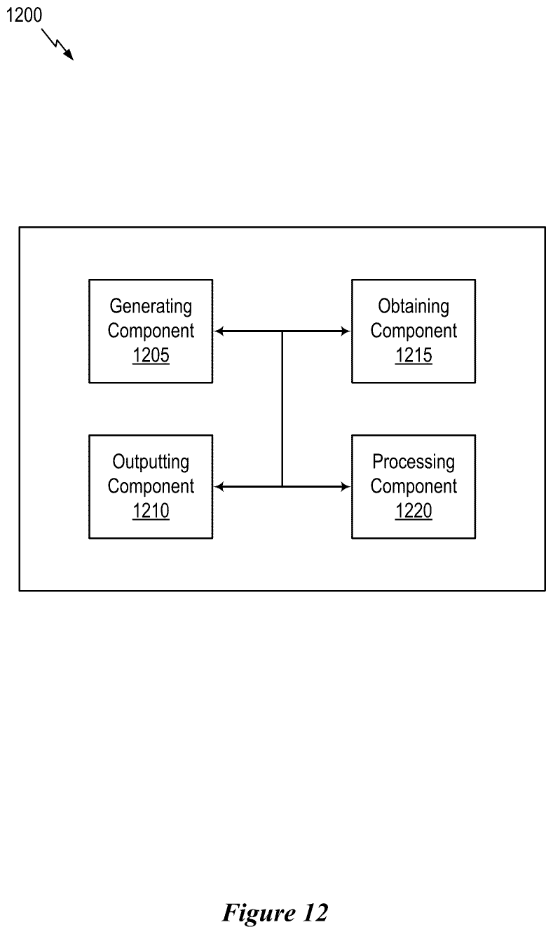

FIG. 10 shows a flowchart illustrating an example process 1000 performable by or at a wireless node. The operations of the process 1000 may be implemented by a wireless STA, or its components as described herein, and/or wireless AP, or its components as described herein. For example, the process 1000 may be performed by a wireless communication device, such as the wireless communication device 1200 described with reference to FIG. 12, operating as or within a wireless STA or operating as or within a wireless AP. In some examples, the process 1000 may be performed by a wireless STA such as one of the STAs 104 described with reference to FIG. 1. In some examples, the process 1000 may be performed by a wireless AP such as one of the APs 102 described with reference to FIG. 1.

In some examples, in block 1005, the wireless node may generate a frame that includes a block of user information fields, wherein information is carried as partial information in at least two of the user information fields. In some cases, the operations of this step refer to, or may be performed by, a generating component as described with reference to FIG. 12.

In some examples, in block 1010, the wireless node may output the frame for transmission to one or more wireless nodes. In some cases, the operations of this step refer to, or may be performed by, an outputting component as described with reference to FIG. 12.

In some aspects, the frame comprises a trigger frame configured to schedule and coordinate transmissions from the wireless nodes.

In some aspects, the information comprises at least one of control information or management information.

In some aspects, each of the at least two of the user information fields includes an identifier of an intended recipient of the information.

In some aspects, each of the at least two of the user information fields includes bits set to a value that indicates the at least two user information fields carry the information.

In some aspects, the information comprises at least one of a frame control sequence (FCS), packet number (PN), or a message integrity check (MIC).

In some aspects, when the information comprises the FCS, PN, and MIC, the at least two user information fields carrying partial information associated with the FCS, PN, and MIC occur in a defined order.

In some aspects, according to the defined order, one or more user information fields carrying partial information associated with the FCS occur after one or more user information fields carrying partial information associated with the PN and MIC.

In some aspects, the partial information in a first of the at least two user information fields comprises a first subset of bits associated with the FCS; and the partial information in a second of the at least two user information fields comprises a second subset of bits associated with the FCS.

In some aspects, a quantity of the first subset of bits is different than a quantity of the second subset of bits.

In some aspects, at least one of: the partial information in a first of the at least two user information fields comprises a first subset of bits associated with the PN and the partial information in a second of the at least two user information fields comprises a second subset of bits associated with the PN; or the partial information in a third of the at least two user information fields comprises a first subset of bits associated with the MIC and the partial information in a fourth of the at least two user information fields comprises a second subset of bits associated with the MIC.

In some aspects, at least one of the user information fields comprises: a subset of bits associated with the FCS; and a subset of bits associated with at least one of the PN or the MIC.

In some aspects, the frame also includes one or more bits indicating at least one of the FCS, MIC, or PN is carried in one or more of the user information fields.

In some aspects, at least one of the PN or MIC is based on a truncated cyclic redundancy check (CRC) size.

In some aspects, the frame also includes a location field that indicates a location, within the frame, of at least one of: a user information field that carries partial information associated with the FCS; a user information field that carries partial information associated with the PN; or a user information field that carries partial information associated with the MIC.

In some aspects, the frame also includes one or more presence bits indicating at least one of the FCS, MIC, or PN is carried in one or more of the user information fields; and the one or more presence bits are configured to enable decoding/interpretation of the location field.

In some aspects, each of the at least two user information fields includes bits set to a value in a range of values that indicates that the at least two user information fields carry the information.

Note that FIG. 10 is just one example of a process, and other processes including fewer, additional, or alternative steps are possible consistent with this disclosure.

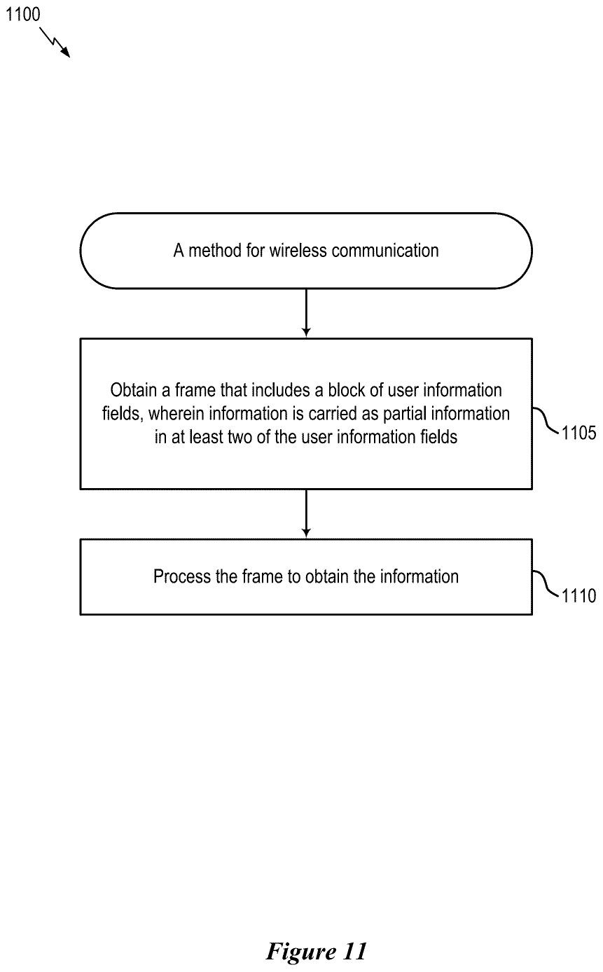

FIG. 11 shows a flowchart illustrating an example process 1100 performable by or at a wireless node. The operations of the process 1100 may be implemented by a wireless STA, or its components as described herein, and/or wireless AP, or its components as described herein. For example, the process 1100 may be performed by a wireless communication device, such as the wireless communication device 1200 described with reference to FIG. 12, operating as or within a wireless STA or operating as or within a wireless AP. In some examples, the process 1100 may be performed by a wireless STA such as one of the STAs 104 described with reference to FIG. 1. In some examples, the process 1100 may be performed by a wireless AP such as one of the APs 102 described with reference to FIG. 1.

In some examples, in block 1105, the wireless node may obtain a frame that includes a block of user information fields, wherein information is carried as partial information in at least two of the user information fields. In some cases, the operations of this step refer to, or may be performed by, an obtaining component as described with reference to FIG. 12.

In some examples, in block 1110, the wireless node may process the frame to obtain the information. In some cases, the operations of this step refer to, or may be performed by, a processing component as described with reference to FIG. 12.

In some aspects, the frame comprises a trigger frame configured to schedule and coordinate transmissions.

In some aspects, the information comprises at least one of control information or management information.

In some aspects, each of the at least two of the user information fields includes an identifier of an intended recipient of the information.

In some aspects, each of the at least two of the user information fields includes bits set to a value that indicates the at least two user information fields carry the information.

In some aspects, the information comprises at least one of a frame control sequence (FCS), packet number (PN), or a message integrity check (MIC).

In some aspects, when the information comprises the FCS, PN, and MIC, the at least two user information fields carrying partial information associated with the FCS, PN, and MIC occur in a defined order.

In some aspects, according to the defined order, one or more user information fields carrying partial information associated with the FCS occur after one or more user information fields carrying partial information associated with the PN and MIC.

In some aspects, the partial information in a first of the at least two user information fields comprises a first subset of bits associated with the FCS; and the partial information in a second of the at least two user information fields comprises a second subset of bits associated with the FCS.

In some aspects, a quantity of the first subset of bits is different than a quantity of the second subset of bits.

In some aspects, at least one of: the partial information in a first of the at least two user information fields comprises a first subset of bits associated with the PN and the partial information in a second of the at least two user information fields comprises a second subset of bits associated with the PN; or the partial information in a third of the at least two user information fields comprises a first subset of bits associated with the MIC and the partial information in a fourth of the at least two user information fields comprises a second subset of bits associated with the MIC.

In some aspects, at least one of the user information fields comprises: a subset of bits associated with the FCS; and a subset of bits associated with at least one of the PN or the MIC.

In some aspects, the frame also includes one or more bits indicating at least one of the FCS, MIC, or PN is carried in one or more of the user information fields.

In some aspects, at least one of the PN or MIC is based on a truncated cyclic redundancy check (CRC) size.

In some aspects, the frame also includes a location field that indicates a location, within the frame, of at least one of: a user information field that carries partial information associated with the FCS; a user information field that carries partial information associated with the PN; or a user information field that carries partial information associated with the MIC.

In some aspects, the frame also includes one or more presence bits indicating at least one of the FCS, MIC, or PN is carried in one or more of the user information fields; and the one or more presence bits are configured to enable decoding/interpretation of the location field.

In some aspects, each of the at least two user information fields includes bits set to a value in a range of values that indicates that the at least two user information fields carry the information.

Note that FIG. 11 is just one example of a process, and other processes including fewer, additional, or alternative steps are possible consistent with this disclosure.

### Example Device(s)

FIG. 12 shows a block diagram of an example wireless communication device 1200. In some examples, the wireless communication device 1200 is configured to perform the process 1000 described with reference to FIG. 10. In some examples, the wireless communication device 1200 is configured to perform the process 1100 described with reference to FIG. 11. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1200 may transmit the information output from the chip. In such an example, the second interface may refer to an interface between the processing system of the chip and a reception component, such that the device 1200 may receive information that is passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in a STA, such as the STA 104 described with reference to FIG. 1. In some other examples, the wireless communication device 1200 can be a STA that includes such a processing system and other components including multiple antennas. In some examples, the wireless communication device 1200 can be configurable or configured for use in an AP, such as the AP 102 described with reference to FIG. 1. In some other examples, the wireless communication device 1200 can be an AP that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes generating component 1205, outputting component 1210, obtaining component 1215, and processing component 1220. Portions of one or more of the components 1205, 1210, 1215, and 1220 may be implemented at least in part in hardware or firmware. For example one or more of the components 1205, 1210, 1215, and 1220 may be implemented at least in part by a processor or a modem. In some examples, portions of one or more of the components 1205, 1210, 1215, and 1220 may be implemented at least in part by a processor and software in the form of processor-executable code stored in a memory.

### Example Clauses

Clause 1: A method for wireless communication, including: generating a frame that includes a block of user information fields, wherein information is carried as partial information in at least two of the user information fields; and outputting the frame for transmission to one or more wireless nodes.
Clause 2: The method of Clause 1, where the frame includes a trigger frame configured to schedule and coordinate transmissions from the wireless nodes.
Clause 3: The method any one of Clauses 1-2, where the information includes at least one of control information or management information.
Clause 4: The method any one of Clauses 1-3, where each of the at least two of the user information fields includes an identifier of an intended recipient of the information.
Clause 5: The method any one of Clauses 1-4, where each of the at least two of the user information fields includes bits set to a value that indicates the at least two user information fields carry the information.
Clause 6: The method any one of Clauses 1-5, where the information includes at least one of a frame control sequence (FCS), packet number (PN), or a message integrity check (MIC).
Clause 7: The method of Clause 6, where when the information includes the FCS, PN, and MIC, the at least two user information fields carrying partial information associated with the FCS, PN, and MIC occur in a defined order.
Clause 8: The method of Clause 7, where according to the defined order, one or more user information fields carrying partial information associated with the FCS occur after one or more user information fields carrying partial information associated with the PN and MIC.
Clause 9: The method of Clause 6, where the partial information in a first of the at least two user information fields includes a first subset of bits associated with the FCS; and the partial information in a second of the at least two user information fields includes a second subset of bits associated with the FCS.
Clause 10: The method of Clause 9, where a quantity of the first subset of bits is different than a quantity of the second subset of bits.
Clause 11: The method of Clause 6, where at least one of: the partial information in a first of the at least two user information fields includes a first subset of bits associated with the PN and the partial information in a second of the at least two user information fields includes a second subset of bits associated with the PN; or the partial information in a third of the at least two user information fields includes a first subset of bits associated with the MIC and the partial information in a fourth of the at least two user information fields includes a second subset of bits associated with the MIC.
Clause 12: The method of Clause 6, where at least one of the user information fields includes: a subset of bits associated with the FCS; and a subset of bits associated with at least one of the PN or the MIC.
Clause 13: The method of Clause 6, where the frame also includes one or more bits indicating at least one of the FCS, MIC, or PN is carried in one or more of the user information fields.
Clause 14: The method of Clause 6, where at least one of the PN or MIC is based on a truncated cyclic redundancy check (CRC) size.
Clause 15: The method of Clause 6, where the frame also includes a location field that indicates a location, within the frame, of at least one of: a user information field that carries partial information associated with the FCS; a user information field that carries partial information associated with the PN; or a user information field that carries partial information associated with the MIC.
Clause 16: The method of Clause 16, where the frame also includes one or more presence bits indicating at least one of the FCS, MIC, or PN is carried in one or more of the user information fields; and the one or more presence bits are configured to enable decoding/interpretation of the location field.
Clause 17: The method any one of Clauses 1-14, where each of the at least two user information fields includes bits set to a value in a range of values that indicates that the at least two user information fields carry the information.
Clause 18: A method for wireless communication, including: obtaining a frame that includes a block of user information fields, wherein information is carried as partial information in at least two of the user information fields; and processing the frame to obtain the information.
Clause 19: The method of Clause 18, where the frame includes a trigger frame configured to schedule and coordinate transmissions.
Clause 20: The method any one of Clauses 18-19, where the information includes at least one of control information or management information.
Clause 21: The method any one of Clauses 18-20, where each of the at least two of the user information fields includes an identifier of an intended recipient of the information.
Clause 22: The method any one of Clauses 18-21, where each of the at least two of the user information fields includes bits set to a value that indicates the at least two user information fields carry the information.
Clause 23: The method any one of Clauses 18-22, where the information includes at least one of a frame control sequence (FCS), packet number (PN), or a message integrity check (MIC).
Clause 24: The method of Clause 23, where when the information includes the FCS, PN, and MIC, the at least two user information fields carrying partial information associated with the FCS, PN, and MIC occur in a defined order.
Clause 25: The method of Clause 24, where according to the defined order, one or more user information fields carrying partial information associated with the FCS occur after one or more user information fields carrying partial information associated with the PN and MIC.
Clause 26: The method of Clause 23, where the partial information in a first of the at least two user information fields includes a first subset of bits associated with the FCS; and the partial information in a second of the at least two user information fields includes a second subset of bits associated with the FCS.
Clause 27: The method of Clause 26, where a quantity of the first subset of bits is different than a quantity of the second subset of bits.
Clause 28: The method of Clause 23, where at least one of: the partial information in a first of the at least two user information fields includes a first subset of bits associated with the PN and the partial information in a second of the at least two user information fields includes a second subset of bits associated with the PN; or the partial information in a third of the at least two user information fields includes a first subset of bits associated with the MIC and the partial information in a fourth of the at least two user information fields includes a second subset of bits associated with the MIC.
Clause 29: The method of Clause 23, where at least one of the user information fields includes: a subset of bits associated with the FCS; and a subset of bits associated with at least one of the PN or the MIC.
Clause 30: The method of Clause 23, where the frame also includes one or more bits indicating at least one of the FCS, MIC, or PN is carried in one or more of the user information fields.
Clause 31: The method of Clause 23, where at least one of the PN or MIC is based on a truncated cyclic redundancy check (CRC) size.
Clause 32: The method of Clause 23, where the frame also includes a location field that indicates a location, within the frame, of at least one of: a user information field that carries partial information associated with the FCS; a user information field that carries partial information associated with the PN; or a user information field that carries partial information associated with the MIC.
Clause 33: The method of Clause 33, where the frame also includes one or more presence bits indicating at least one of the FCS, MIC, or PN is carried in one or more of the user information fields; and the one or more presence bits are configured to enable decoding/interpretation of the location field.
Clause 34: The method any one of Clauses 18-31, where each of the at least two user information fields includes bits set to a value in a range of values that indicates that the at least two user information fields carry the information.
Clause 35: An apparatus, including: at least one memory including executable instructions; and at least one processor configured to execute the executable instructions and cause the apparatus to perform a method in accordance with any combination of Clauses 1-34.
Clause 36: An apparatus, including means for performing a method in accordance with any combination of Clauses 1-34.
Clause 37: A non-transitory computer-readable medium including executable instructions that, when executed by at least one processor of an apparatus, cause the apparatus to perform a method in accordance with any combination of Clauses 1-34.
Clause 38: A computer program product embodied on a computer-readable storage medium including code for performing a method in accordance with any combination of Clauses 1-34.
Clause 39: A wireless node (e.g., an access point (AP)), including: at least one transceiver, at least one memory including instructions; and at least one processor configured to execute the instructions to cause the apparatus to perform a method in accordance with any combination of Clauses 1-17, wherein the at least one transceiver is configured to transmit the frame.
Clause 40: A wireless node (e.g., a wireless station), including: at least one transceiver, at least one memory including instructions; and at least one processor configured to execute the instructions to cause the apparatus to perform a method in accordance with any combination of Clauses 18-34, wherein the at least one transceiver is configured to receive the frame.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

Means for outputting, means for participating, and means for obtaining may comprise one or more processors, such as one or more of the processors described above with reference to FIG. 40.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

Means for generating, means for outputting, means for obtaining, and means for processing may comprise one or more processors such as one or more of the processors described herein (e.g., with reference to FIG. 12).

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one transceiver;
at least one memory comprising instructions; and
one or more processors configured to execute the instructions to cause the apparatus to:
generate a frame that includes a block of user information fields, wherein information is carried as partial information in at least two of the user information fields; and
transmit, via the at least one transceiver, the frame for transmission to one or more wireless nodes.

2. The apparatus of claim 1, wherein the frame comprises a trigger frame configured to schedule and coordinate transmissions from the wireless nodes.

3. The apparatus of claim 1, wherein the information comprises at least one of control information or management information.

4. The apparatus of claim 1, wherein each of the at least two of the user information fields includes an identifier of an intended recipient of the information.

5. The apparatus of claim 1, wherein each of the at least two of the user information fields includes bits set to a value that indicates the at least two user information fields carry the information.

6. The apparatus of claim 1, wherein the information comprises at least one of a frame control sequence (FCS), packet number (PN), or a message integrity check (MIC).

7. The apparatus of claim 6, wherein:
when the information comprises the FCS, PN, and MIC, the at least two user information fields carrying partial information associated with the FCS, PN, and MIC occur in a defined order.

8. The apparatus of claim 7, wherein:
according to the defined order, one or more user information fields carrying partial information associated with the FCS occur after one or more user information fields carrying partial information associated with the PN and MIC.

9. The apparatus of claim 6, wherein:
the partial information in a first of the at least two user information fields comprises a first subset of bits associated with the FCS; and
the partial information in a second of the at least two user information fields comprises a second subset of bits associated with the FCS.

10. The apparatus of claim 9, wherein a quantity of the first subset of bits is different than a quantity of the second subset of bits.

11. The apparatus of claim 6, wherein at least one of:
the partial information in a first of the at least two user information fields comprises a first subset of bits associated with the PN and the partial information in a second of the at least two user information fields comprises a second subset of bits associated with the PN; or
the partial information in a third of the at least two user information fields comprises a first subset of bits associated with the MIC and the partial information in a fourth of the at least two user information fields comprises a second subset of bits associated with the MIC.

12. The apparatus of claim 6, wherein at least one of the user information fields comprises:
a subset of bits associated with the FCS; and
a subset of bits associated with at least one of the PN or the MIC.

13. The apparatus of claim 6, wherein:
the frame also includes one or more bits indicating at least one of the FCS, MIC, or PN is carried in one or more of the user information fields.

14. The apparatus of claim 6, wherein at least one of the PN or MIC is based on a truncated cyclic redundancy check (CRC) size.

15. The apparatus of claim 1, wherein each of the at least two user information fields includes bits set to a value in a range of values that indicates that the at least two user information fields carry the information.

16. The apparatus of claim 6, wherein the frame also includes a location field that indicates a location, within the frame, of at least one of:
a user information field that carries partial information associated with the FCS;
a user information field that carries partial information associated with the PN; or
a user information field that carries partial information associated with the MIC.

17. The apparatus of claim 16, wherein:
the frame also includes one or more presence bits indicating at least one of the FCS, MIC, or PN is carried in one or more of the user information fields; and
the one or more presence bits are configured to enable decoding/interpretation of the location field.

18. An apparatus for wireless communication, comprising:
at least one transceiver;
at least one memory comprising instructions; and
one or more processors configured to execute the instructions to cause the apparatus to:
receive, via the at least one transceiver, a frame that includes a block of user information fields, wherein information is carried as partial information in at least two of the user information fields; and
process the frame to obtain the information.

19. The apparatus of claim 18, wherein the frame comprises a trigger frame configured to schedule and coordinate transmissions.

20. The apparatus of claim 18, wherein the information comprises at least one of control information or management information.

21. The apparatus of claim 18, wherein each of the at least two of the user information fields includes an identifier of an intended recipient of the information.

22. The apparatus of claim 18, wherein each of the at least two of the user information fields includes bits set to a value that indicates the at least two user information fields carry the information.

23. The apparatus of claim 18, wherein the information comprises at least one of a frame control sequence (FCS), packet number (PN), or a message integrity check (MIC).

24. The apparatus of claim 23, wherein:
when the information comprises the FCS, PN, and MIC, the at least two user information fields carrying partial information associated with the FCS, PN, and MIC occur in a defined order.

25. The apparatus of claim 24, wherein:
according to the defined order, one or more user information fields carrying partial information associated with the FCS occur after one or more user information fields carrying partial information associated with the PN and MIC.

26. The apparatus of claim 23, wherein:
the partial information in a first of the at least two user information fields comprises a first subset of bits associated with the FCS; and
the partial information in a second of the at least two user information fields comprises a second subset of bits associated with the FCS.

27. The apparatus of claim 26, wherein a quantity of the first subset of bits is different than a quantity of the second subset of bits.

28. The apparatus of claim 23, wherein at least one of:
the partial information in a first of the at least two user information fields comprises a first subset of bits associated with the PN and the partial information in a second of the at least two user information fields comprises a second subset of bits associated with the PN; or
the partial information in a third of the at least two user information fields comprises a first subset of bits associated with the MIC and the partial information in a fourth of the at least two user information fields comprises a second subset of bits associated with the MIC.

29. The apparatus of claim 23, wherein at least one of the user information fields comprises:
a subset of bits associated with the FCS; and
a subset of bits associated with at least one of the PN or the MIC.

30. The apparatus of claim 23, wherein:
the frame also includes one or more bits indicating at least one of the FCS, MIC, or PN is carried in one or more of the user information fields.
